(19) United States
(12) Patent Application Publication
(10) Pub. No.: US 2014/0340825 A1
(43) Pub. Date: Nov. 20, 2014

(54) ELECTRONIC DEVICE

(71) Applicants: INVENTEC CORPORATION, Taipei (TW); Inventec (Pudong) Technology Corporation, Shanghai (CN)

(72) Inventor: Chun-Chi LIN, Taipei (TW)

(73) Assignees: INVENTEC CORPORATION, Taipei (TW); Inventec (Pudong) Technology Corporation, Shanghai (CN)

(21) Appl. No.: 14/223,745

(22) Filed: Mar. 24, 2014

(30) Foreign Application Priority Data
May 15, 2013 (CN) 201310178721.7

(51) Int. Cl. G06F 1/16

(52) U.S. Cl. CPC G06F 1/1667; G06F 1/1681
USPC 361/679.11

(57) ABSTRACT

An electronic device includes a case, a display unit and a flexible input unit. The case has a front side and a first lateral side. The case has an opening located on the first lateral side. The display unit is disposed on the front side. The flexible input unit has a first end and a second end opposite to each other. The flexible input unit is disposed through the opening to cause the first end to be disposed inside the case while the second end outside the case. The flexible input unit is capable of moving in the case, so as to cause the second end to be close to or away from the opening.

### CROSS-REFERENCE TO RELATED APPLICATIONS

This non-provisional application claims priority under 35 U.S.C. §119(a) on Patent Application No(s). 201310178721.7 filed in China, P.R.C. on May 15, 2013, the entire contents of which are hereby incorporated by reference.

### BACKGROUND

1. Technical Field of the Invention

The disclosure relates to an electronic device, more particularly to an electronic device having an input module.

2. Description of the Related Art

In today's technology, when entering the text data into an electronic device having a touch panel, a virtual keyboard generated by the application is generally used for inputting data through touching the virtual keyboard. In order to make the virtual keyboard easier to use and to prevent the users from pressing the wrong keys of the virtual keyboard, the size of the virtual keyboard cannot be too small. As a result, a large proportion of the touch panel is covered by the virtual keyboard and this reduces the size of the original display range. Since the information users can browse becomes less, users may feel inconvenient. Thus, the external keyboard is introduced by the related industries.

The external keyboard, however, is additional equipment for users to carry. Besides, it adds an extra weight to the electronic device. These problems become a burden on the issue of portability.

### SUMMARY OF THE INVENTION

An electronic device comprises a case, a display unit and a flexible input unit. The case has a front side and a first lateral side. The case has an opening located on the first lateral side. The display unit is disposed on the front side. The flexible input unit has a first end and a second end opposite to each other. The flexible input unit is disposed through the opening to cause the first end to be disposed inside the case while the second end outside the case. The flexible input unit is configured for moving in the case, so as to cause the second end to be close to or away from the opening.

### BRIEF DESCRIPTION OF THE DRAWINGS

The disclosure will become more fully understood from the detailed description given herein below for illustration only and thus does not limit of the disclosure, wherein:

FIG. 1 is a perspective view of an electronic device according to an embodiment of the disclosure;

FIG. 2A is side view of the electronic device when the flexible input unit is in a storage position according to FIG. 1;

FIG. 2B is side view of the electronic device when the flexible input unit is in an expanding position according to FIG. 1;

FIG. 2C is side view of the electronic device when the flexible input unit is in an cover position according to FIG. 1;

FIG. 3A is a side view of the electronic device according to another embodiment of the disclosure, wherein the flexible input unit is in a storage position;

FIG. 3B is a side view of the electronic device when the flexible input unit is in an expanding position according to FIG. 3A; and

FIG. 3C is the electronic device when the flexible input unit is in a cover position according to FIG. 3A.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known components and devices are schematically shown in order to simplify the drawing.

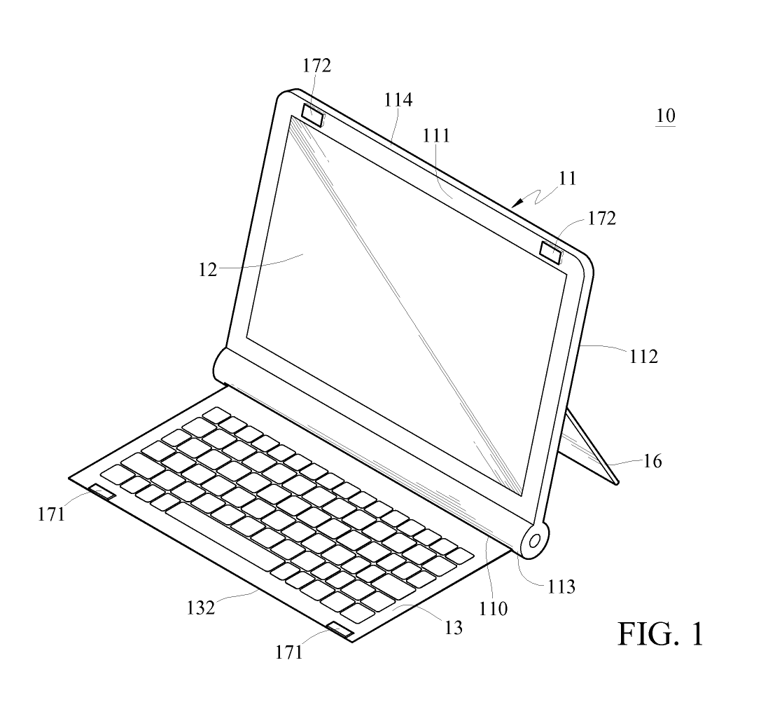

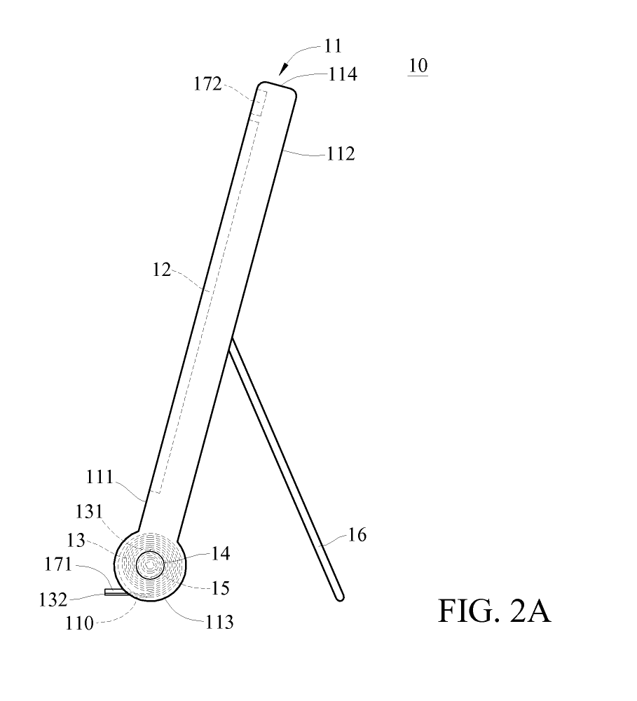

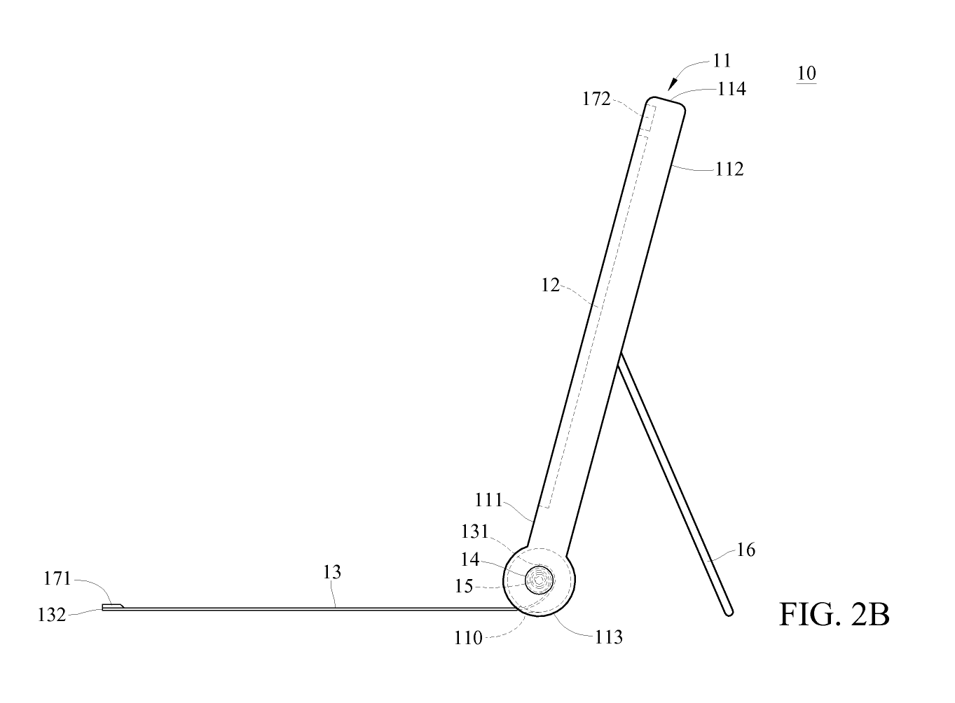

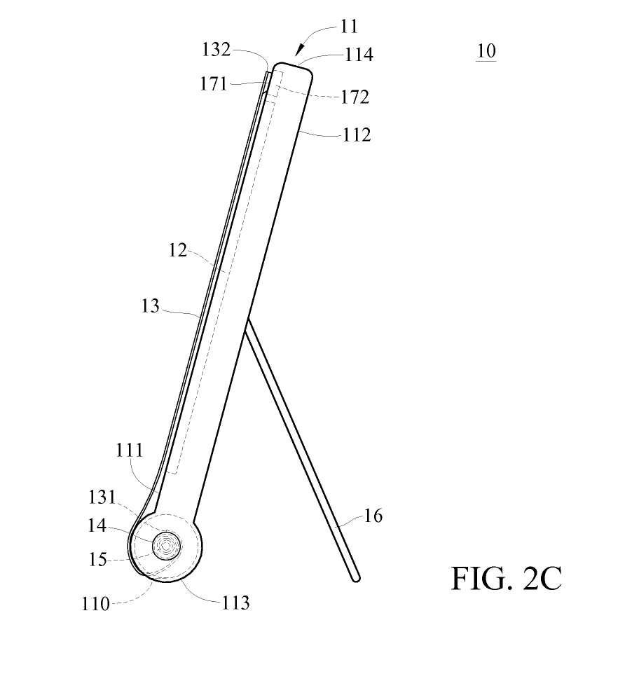

Referring to FIG. 1 and FIG. 2A, FIG. 1 is a perspective view of an electronic device according to an embodiment of the disclosure; FIG. 2A is side view of the electronic device when the flexible input unit is in a storage position according to FIG. 1. In this embodiment, the electronic device comprises a case 11, a display unit 12, a flexible input unit 13, a reel 14, an elastic member 15, a stand 16, a first fastening portion 171 and a second fastening portion 172.

The case 11 has a front side 111 and a back side 112 opposite to each other and a first lateral side 113 and a second lateral side 114 opposite to each other. The case 11 has an opening 110 located on the first lateral side 113. The display unit 12 is disposed on the front side 111. The flexible input unit 13 has a first end 131 and a second end 132. The flexible input unit 13 is disposed through the opening 110 to cause the first end 131 to be disposed inside the case 11, and to cause the second end 132 to be disposed outside the case 11. The flexible input unit 13 is configured for moving in the case 11, so as to make the second end 132 to be close to or away from the opening 110.

The reel 14 is pivoted inside the case 11. The first end 131 of the flexible input unit 13 is connected to the reel 14. The elastic member 15 is disposed inside the case 11 and connects the reel 14 and the case 11. The stand 16 is disposed on the back side 112. The first fastening portion 171 is disposed on the second end 132 of the flexible input unit 13. The second fastening portion 172 is disposed on the second lateral side 114.

In this embodiment, the display unit 12 comprises a display panel. The display panel may be touch panel. The flexible input unit 13 comprises a keyboard. The keyboard may be a touch keyboard.

In this embodiment, one of the first fastening portion 171 and the second fastening portion 172 is made by magnetic material. For example, the first fastening portion may be a magnet, while the second fastening portion 172 may be an iron piece which is magnetizable. In other embodiments, the first fastening portion 171 may be an iron magnetic which is magnetizable, while the second fastening portion 172 may be a magnet. In other embodiments, one of the first fastening portion 171 and the second fastening portion 172 has a hooking structure. For instance, the first fastening portion 171 may have a hook, while the second fastening portion 172 may have a fastening groove. In other embodiments, the first fastening portion 171 may have a fastening grove, while the second fastening portion 172 may have a hook. Alternatively, both the first fastening portion 171 and the second fastening portion 172 have a hook respectively.

Referring to FIG. 2A and FIG. 2B, FIG. 2B is side view of the electronic device when the flexible input unit is in an expanding position according to FIG. 1. As seen in FIG. 2A, when the flexible input unit 13 is in a storage position, the flexible input unit 13 surrounds the reel 14, and the second end 132 is close to the opening 110. As seen in FIG. 2B, when the flexible input unit 13 is in the expanding position, the second end 132 is away form the opening 110. When the flexible input unit 13 is in the storage position, the deformation amount of the elastic member 15 is relatively small, or the elastic member 15 even does not deform. When the flexible input unit 13 is in the expanding position, the elastic member 15 has resilience relative to the reel 14, so as to cause the flexible input unit 13 to back to the storage position.

When the users want to use the flexible input unit 13 to perform input operation, the flexible input unit can be moved from the storage position to the expanding position by pulling it. The users may press the flexible input unit 13 to prevent it from backing to the storage position. When the users want to restore the flexible input unit 13 to the storage position, the users may release the flexible input unit 13, so that the flexible input unit 13 can back to the storage position by the elastic member 15. In other embodiments, the electronic can have a switch (not shown in the figures). When the switch is off, the flexible input unit 13 can be fixed to the expanding position temporarily. When the users want to restore the flexible input unit 13 to the storage position, the switch can be opened to release the flexible input unit 13, so that the flexible input unit 13 can be driven to the storage position via the elastic member 15.

FIG. 2C is side view of the electronic device when the flexible input unit is in a cover position according to FIG. 1. As seen in FIG. 2C, when the flexible input unit 13 is dragged out, it is configured for covering the front side 111 of the case 11 and the display unit 12, so as to avoid dust falling on the display unit 12. At this point, the first fastening portion 171 corresponds to the second fastening portion 172 and both are fastened with each other. For example, one of the first fastening portion 171 and the second fastening portion 172 can attract the other by the magnetic force. In other embodiments, the first fastening portion 171 and the second fastening portion 172 are interfered with each other and therefore fastened with each other.

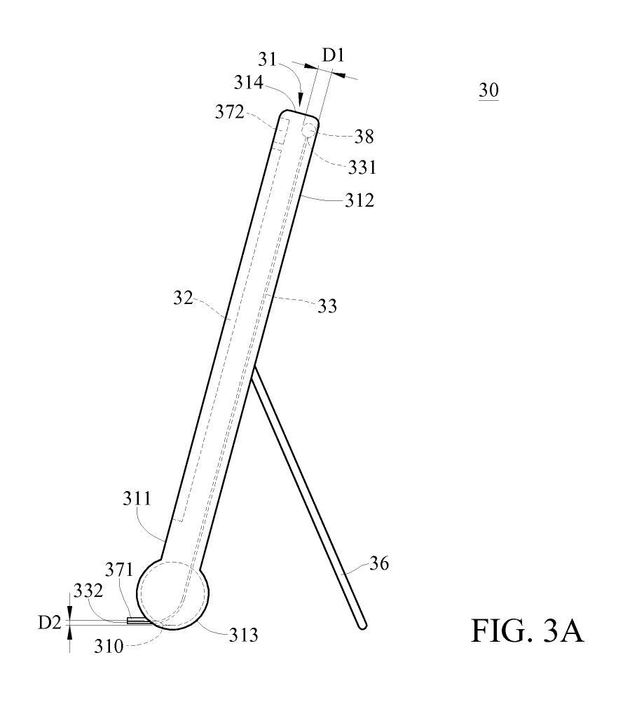

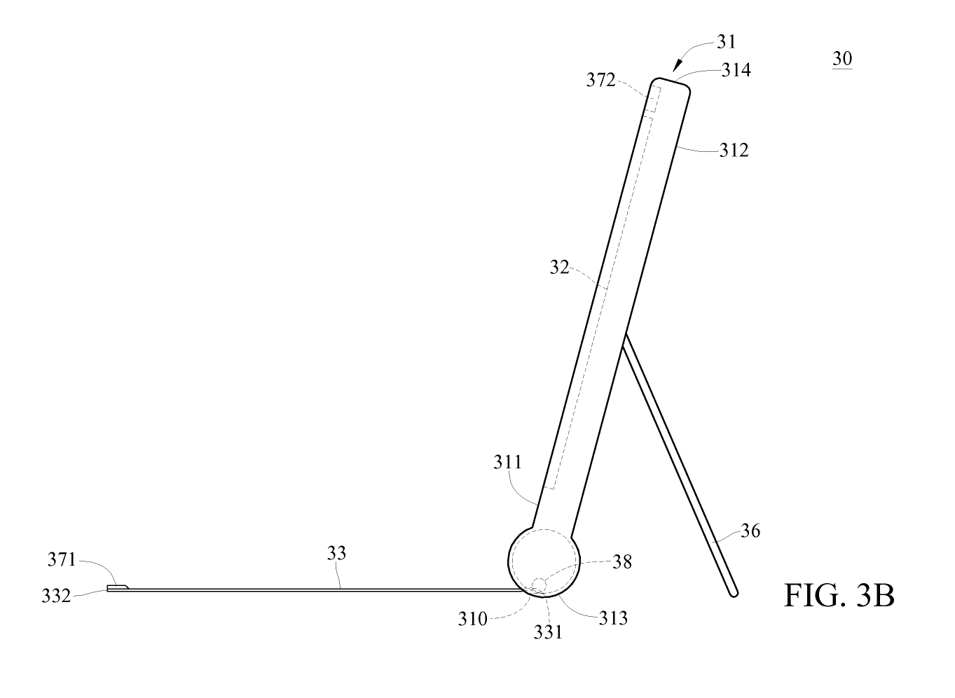

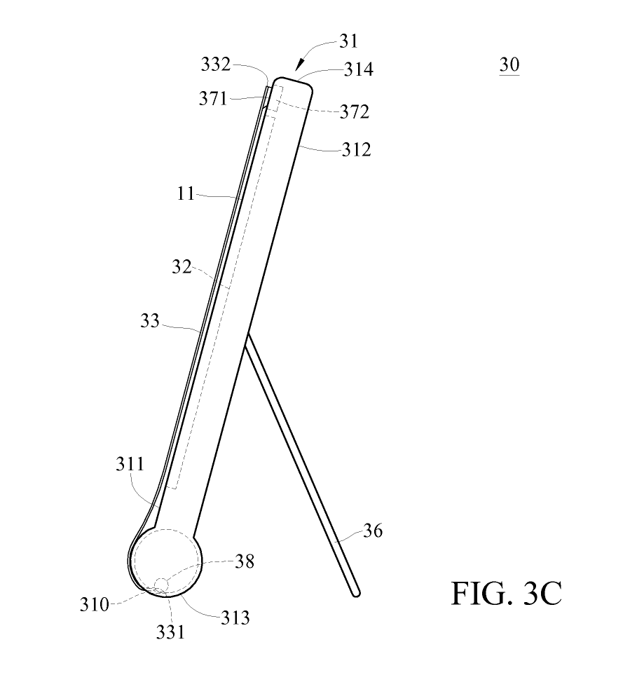

FIG. 3A is a side view of the electronic device according to another embodiment of the disclosure, wherein the flexible input unit is in a storage position. As seen in FIG. 3A, the electronic device 30, similar to the electronic device in FIG. 2A, comprises a case 31, a display unit 32, a flexible input unit 33, a stand 36, a first fastening portion 371 and a second fastening portion 372. The display unit 32 is disposed on the front side 311 of the case 31. The flexible input unit 33 is disposed through the opening 310 located on the first lateral side 313 of the case 31, so as to cause the first end 331 to be disposed inside the case 31, and to cause the second end 332 to be disposed outside the case 31. The flexible input unit 33 is configured for moving in the case, so as to make the second end 332 be close to or away from the opening 310. The stand 36 is disposed on the back side of the case 31. The first fastening portion 371 is disposed on the second end 332 of the flexible input unit 33. The second fastening portion 372 is disposed on the second lateral side 314 of the case 31.

However, in this embodiment, the electronic device 30 further comprises a block 38 disposed inside the case 31 and connected to the first end 331 of the flexible input unit 33. The width D1 of the block 38 is greater than the width D2 of the opening 310.

Referring to FIG. 3A and FIG. 3B, FIG. 3B is a side view of the electronic device when the flexible input unit is in an expanding position according to FIG. 3A. As seen in FIG. 3A, when the flexible input unit 33 is in a storage position, the second end 332 is close to the opening 310. As seen in FIG. 3B, when the flexible input unit 33 is in the expanding position, the second end 332 is away form the opening 310. In this embodiment, since the width D1 of the block 38 is greater than the width D2 of the opening 310, the block 38 can be kept in the case 31 and does not fall out from the opening 310. Hence, the position of the first end 331 of the flexible input unit 33 is maintained inside the case 31. In other embodiments, the width D1 of the block 38 and the width D2 of the opening 310 is not limited to the dimension shown in FIG. 3A. In other words, the dimension of them may be, for example, parallel to the normal vector of the paper (namely the dimension perpendicular to the paper).

When the users want to use the flexible input unit 33 to perform the input operation, they can pull the flexible input unit 33 from the storage position to the expanding position. When the users want to restore the flexible input unit 33 in the storage position, the users can push the flexible input module 33 to inside of the case 31 directly.

FIG. 3C is the electronic device when the flexible input unit is in a cover position according to FIG. 3A. As seen in FIG. 3C, when the flexible input unit 33 is pulled out, it can be made to cover the front side 311 of the case 31 and the display unit 32, so as to prevent dust from falling on the display unit 32. At this point, the first fastening portion 371 corresponds to the second fastening portion 372 and both are fastened with each other. For instance, one of the first fastening portion 371 and the second fastening portion 372 can attract the other via the magnetic force. In other embodiments, the first fastening portion 371 and the second fastening portion 372 are interfered with each other and therefore fastened with each other.

According to the above-mentioned embodiments, in the electronic of the disclosure, since the flexible input unit is disposed inside the case and the flexible input unit can move in the case, it can be restored in the case. Moreover, since the flexible input unit covers the display unit, dust is prevented from falling on the display unit.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An electronic device comprising:
a case having a front side and a first lateral side, the case having an opening located on the first lateral side;
a display unit disposed on the front side; and
a flexible input unit having a first end and a second end opposite to each other, the flexible input unit being disposed through the opening to cause the first end to be disposed inside the case while the second end outside the case, the flexible input unit being configured for moving in the case, so as to cause the second end to be close to or away from the opening.

2. The electronic device according to claim 1, further comprising a reel disposed inside the case, the first end of the flexible input unit being connected to the reel, wherein when the flexible input unit is in a storage position, the flexible input unit surrounds the reel and the second end is close to the opening, and when the flexible input unit is in an expanding position, the second end is away from the opening.

3. The electronic device according to claim 2, further comprising an elastic member disposed inside the case and connected to the flexible input unit, wherein the deformation amount of the elastic member when the flexible input unit is in the storage position is less than the deformation amount of the elastic member when the flexible input unit is in the expanding position.

4. The electronic device according to claim 1, further comprising a block disposed inside the case and connected to the flexible input unit, the width of the block being greater than the width of the opening.

5. The electronic device according to claim 1, further comprising a stand, the case having a back side opposite to the front side, the stand being disposed on the back side.

6. The electronic device according to claim 1, further comprising a first fastening portion and a second fastening portion, the first fastening portion being disposed on the second end of the flexible input unit, the second fastening portion being disposed on a second lateral side opposite to the first lateral side, wherein when the flexible input unit is in a cover position, the flexible input unit covers the front side of the case and the display unit, and the first fastening portion corresponds to the second fastening portion.

7. The electronic device according to claim 6, wherein one of the first fastening portion and the second fastening portion is made by magnetic material.

8. The electronic device according to claim 6, wherein one of the first fastening portion and the second fastening portion has a hooking structure.

9. The electronic device according to claim 1, wherein the display unit comprises a touch panel.

10. The electronic device according to claim 1, wherein the flexible input unit comprises a keyboard.
